(19) United States
(12) Patent Application Publication
(10) Pub. No.: US 2005/0087899 A1
(43) Pub. Date: Apr. 28, 2005

(54) Baffle and method of forming same

(75) Inventors: Thomas Coon, Lapeer, MI (US); Christopher Hable, Romeo, MI (US)

Correspondence Address: Scott A. Chapple, Suite 311, 401 South Old Woodward Avenue, Birmingham, MI, 48009, US

(73) Assignee: L&L Products, Inc., Romeo, MI (US)

(21) Appl. No.: 10/920,520

(22) Filed: Aug. 18, 2004

Related U.S. Application Data
(60) Provisional application No. 60/513,491, filed on Oct. 22, 2003.

(51) Int. Cl. B29C 44/12

(52) U.S. Cl. 264/46.4

(57) ABSTRACT

There is disclosed a baffle for sealing, baffling, absorbing or blocking sound and/or reinforcing components of an article of manufacture such as an automotive vehicle. The assembly generally includes a mass of expandable material an a layer over at least a portion of the expandable material.

### CLAIM OF BENEFIT OF FILING DATE

The present application claims the benefit of the filing date of U.S. Provisional Application Ser. No. 60/513,491, filed Oct. 22, 2003, hereby incorporated by reference.

### FIELD OF THE INVENTION

The present invention relates generally to a baffle, which is employed for providing sealing, baffling, noise/vibration reduction, a combination thereof or the like.

### BACKGROUND OF THE INVENTION

For many years, industry and particularly the transportation industry, has been concerned with designing baffles for providing baffling, sealing, noise/vibration reduction, reinforcement, low air passage (e.g., low cubic feet per minute (CFM) passage) or the like to automotive vehicles. Often these baffles include an expandable material combined with other components for forming the baffle such that the baffle may be located within a cavity of an automotive vehicle.

Formation of these baffles can present a variety of difficulties in formation, application, operation or the like. As one example, formation of the baffles can be costly and labor intensive. Moreover, difficulties can be presented in designing baffles of different shapes without incurring undesirable design and processing costs. Still further, components for controlling the expansion of the expandable material of the baffles can be costly. Thus, the present invention seeks to provide a baffle that overcomes one or more of these difficulties or provides other advantages, which will become apparent upon reading the detailed description of the invention.

### SUMMARY OF THE INVENTION

According to at least one embodiment of the invention, there is disclosed a method of forming and using a baffle. According to the method, a mass of expandable material is provided. The mass typically includes a first surface opposite a second surface. At least one opening may be formed in the mass of expandable material and the opening may extend through the first surface, the second surface or both. A liquid coating material is typically applied to the first surface, the second surface or both and may be at least partially applied within the at least one opening. Preferably, the coating material is at least partially cured for forming a first layer overlapping the first surface and possibly a second layer overlapping the second surface. The curing may also form a connection member, which interconnects the first layer to the second layer through the opening. The mass of expandable material may be further shaped as well. For example, the mass, the first layer and the second layer may be die cut or otherwise shaped for forming the baffle such that the baffle has a peripheral wall at least partially defined by the first layer, the second layer and the mass of expandable material. In one application, the baffle is positioned within a cavity of a structure such that the peripheral edge opposes one or more walls defining the cavity. The mass of expandable material is typically expanded and may be expanded to contact the one or more walls defining the cavity. Typically, the first layer, the second layer or both limit expansion of the expandable material toward the first layer and second layer.

### BRIEF DESCRIPTION OF THE DRAWINGS

The features and inventive aspects of the present invention will become more apparent upon reading the following detailed description, claims, and drawings, of which the following is a brief description:

FIG. 1 is a schematic diagram of an exemplary process suitable for forming a baffle according to the present invention.

FIG. 2 is a sectional view of an exemplary expandable material suitable for forming a baffle according to the present invention.

FIGS. 3A and 3B are respectively a perspective view and a sectional view of the expandable material of FIG. 2 with openings formed therein.

FIG. 4 is a sectional view of the expandable material of FIG. 2 with an exemplary coating material applied thereto.

FIG. 5 is a sectional view of the expandable material and coating material of FIG. 4 after at least partial curing of the coating material.

FIG. 6 is an elevational view of an exemplary baffle formed in accordance with the present invention.

FIG. 6A is a side view of a portion of the exemplary baffle of FIG. 6.

FIG. 7 is an elevational of another exemplary baffle formed in accordance with the present invention.

FIG. 8A is a perspective view of another exemplary baffle formed in accordance with the present invention.

FIG. 8B is an elevational view of the baffle of FIG. 8A assembled to a structure of an automotive vehicle.

### DETAILED DESCRIPTION OF THE PREFERRED EMBODIMENT

The present invention is predicated upon the provision of a baffle for providing baffling, sealing, noise absorption, reinforcement, a combination thereof or the like to an article of manufacture. It is contemplated that the baffle may be applied (e.g., assembled) to various article of manufacture such as boats, trains, buildings, appliances, homes, furniture or the like. It has been found, however, that the member is particularly suitable for application to automotive vehicles.

The baffle typically includes:
a) a mass of expandable material having one or more surfaces; and
b) one or more layers covering one or more portions of the one or more surfaces such that the one or more surfaces comprise one or more exposed surfaces and one or more covered surfaces.

The one or more layers are preferably formed of a cured coating material, although not required. The one or more layers also preferably limits any expansion of the expandable material toward themselves.

The baffle and, more particularly, the mass of expandable material may be configured in a variety of shapes and sizes depending upon the structure to which the baffle will be applied. In one particular embodiment, the mass, the baffle or both are shaped to correspond to a cavity that is defined by one or more walls of a structure of an article of manufacture such as an automotive vehicle. In such an embodiment, the baffle is typically located within the cavity of the structure and the expandable material is typically expanded to provide baffling, sealing and possibly reinforcement to the article. Advantageously, the one or more layers of the baffle can at least partially assist in controlling the direction of expansion of the expandable material.

The one or more layers are typically formed by applying a substantially liquid coating material directly to the one or more portions of the surface of the expandable material followed by at least partially curing the coating material. However, it is contemplated that the one or more layers may be pre-formed and applied to the expandable material in a solid or semi-solid state. Additionally, it is contemplated that the one or more layers may be applied to other components or materials, which are attached to the expandable material.

The baffle may or may not include one or more fasteners for assisting in locating the baffle relative to a structure. When included, such fasteners can be provided as additional components attached to the one or more layers, the expandable material or both. Alternatively, the fasteners may be formed by the one or more layers, the expandable material or a combination thereof.

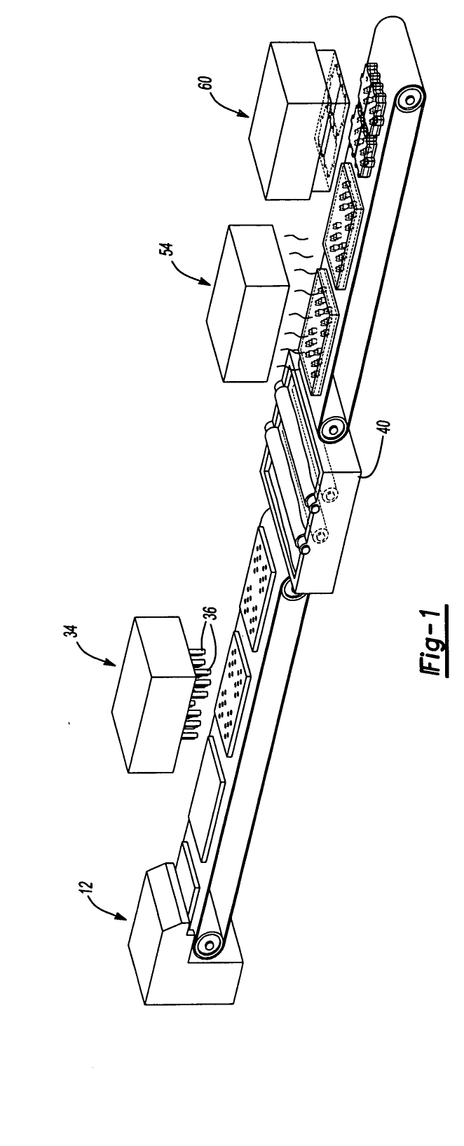

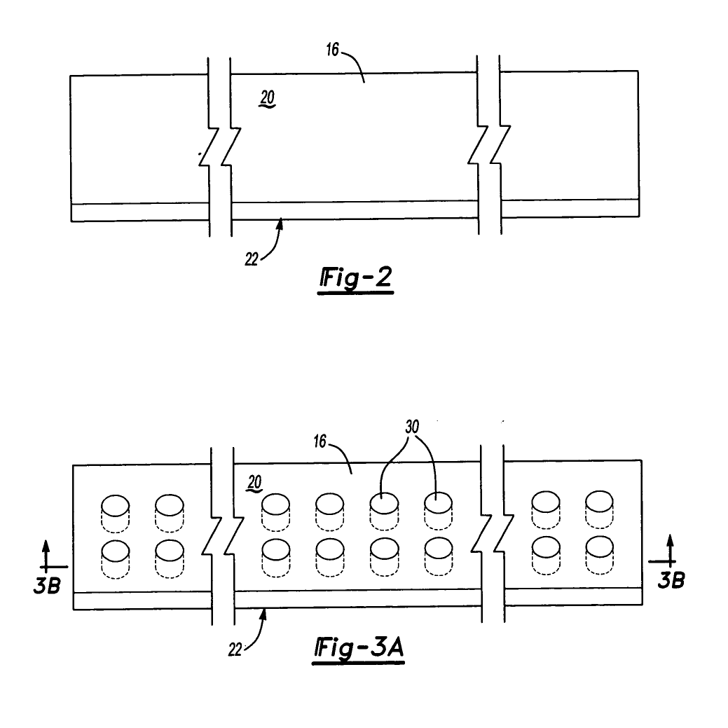

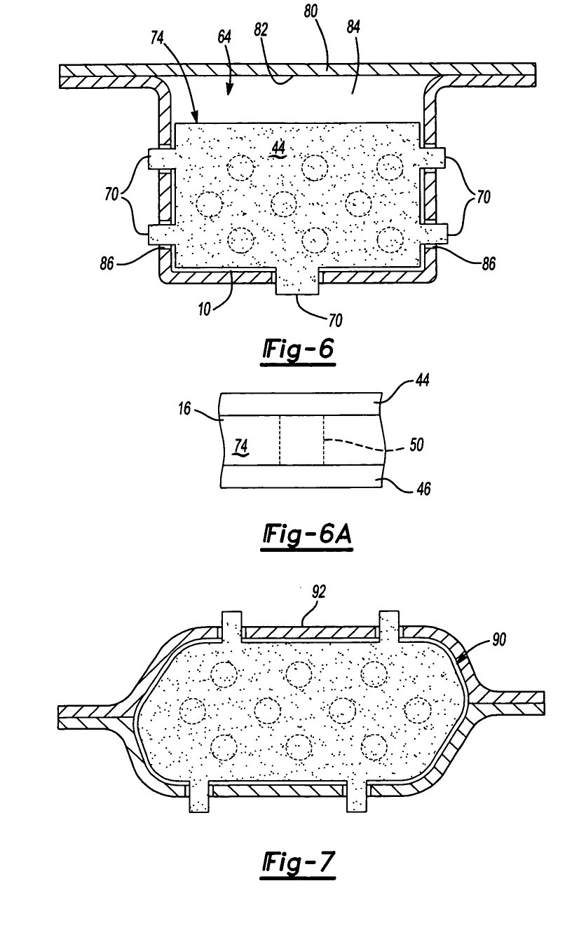

In FIG. 6, there is illustrated one exemplary baffle 10 formed in accordance with the present invention. The process employed to form the baffle 10 is illustrated in FIGS. 1-5. According to the process, expandable material is typically provided in a desired configuration. In the embodiment illustrated, an extruder 12 is employed to extrude the expandable material into a layer 16 having a first surface 20 opposite a second surface 22. Of course, it is contemplated that the expandable material may be provided in a variety of configurations using a variety of techniques. Some of those configurations and techniques are discussed herein, however, it should be understood that the skilled artisan will be able to provide additional techniques and configurations within the scope of the present invention.

The expandable material may be formed of a variety of suitable materials. Preferably, the expandable material is formed of a heat activated material having foamable characteristics. The material may be generally dry to the touch or tacky and may be shaped in any form of desired pattern, placement, or thickness, but is preferably of substantially uniform thickness.

Though other heat-activated materials are possible for the expandable material, a preferred heat activated material is a cross-linkable expandable polymer or plastic, and preferably one that is foamable. Examples of suitable expandable materials include L2105, L7102, L2603 and other materials that are commercially available from L&L Products of Romeo, Mich. A particularly preferred material is a relatively high expansion foam having a polymeric formulation that includes one or more of an epoxy, an acrylate, an acetate, an elastomer, a combination thereof or the like. For example, and without limitation, the foam may be an EVA/rubber based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of baffling or sealing foams are known in the art and may also be used to produce the foam. A typical foam includes a polymeric base material, such as one or more ethylene-based polymers which, when compounded with appropriate ingredients (typically a blowing and curing agent), expands and cures in a reliable and predictable manner upon the application of heat or the occurrence of a particular ambient condition. From a chemical standpoint for a thermally-activated material, the foam, which may be structural or acoustical, is usually initially processed as a flowable material before curing, and upon curing, the material will typically cross-link making the material incapable of further flow.

One advantage of the preferred foam materials over prior art materials is that the preferred materials can be processed in several ways. The preferred materials can be processed by injection molding, extrusion compression molding or with a mini-applicator. This enables the formation and creation of part designs that exceed the capability of most prior art materials.

While the preferred materials for fabricating the expandable material has been disclosed, the expandable material can be formed of other materials provided that the material selected is heat-activated or otherwise activated by an ambient condition (e.g. moisture, pressure, time or the like) and cures in a predictable and reliable mariner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials. See also, U.S. Pat. Nos. 5,766,719; 5,755,486; 5,575,526; and 5,932,680, (incorporated by reference). Preferably, the material has good adhesion durability properties for providing a well-bonded baffle and does not generally interfere with the materials systems employed by automobile or other manufacturers.

In applications where the expandable material is a heat activated, thermally expanding material, an important consideration involved with the selection and formulation of the material comprising the foam is the temperature at which a material reaction or expansion, and possibly curing, will take place. Typically, the foam becomes reactive at higher processing temperatures, such as those encountered in an automobile assembly plant, when the foam is processed along with the automobile components at elevated temperatures or at higher applied energy levels, e.g., during paint curing steps. While temperatures encountered in an automobile assembly operation may be in the range of about 148.89° C. to 204.44° C. (about 300° F. to 400° F.), body and paint shop applications are commonly about 93.33° C. (about 200° F.), but may be higher or lower. If needed, blowing agent activators can be incorporated into the composition to cause expansion at different temperatures outside the above ranges. Generally, suitable expandable foams have a range of expansion ranging from approximately 0 to over 1000 percent.

In another embodiment, the expandable material is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

It is contemplated that the expandable material could be delivered and placed into contact with the coating material, the layers or a structure, through a variety of delivery systems which include, but are not limited to, a mechanical snap fit assembly, extrusion techniques commonly known in the art as well as a mini-applicator technique as in accordance with the teachings of commonly owned U.S. Pat. No. 5,358,397 (“Apparatus For Extruding Flowable Materials”), hereby expressly incorporated by reference. In this non-limiting embodiment, the material or medium is at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) wherein the foamable or expandable material can be snap-fit onto the chosen surface or substrate; placed into beads or pellets for placement along the chosen substrate or member by means of extrusion; placed along the substrate through the use of baffle technology; a die-cast application according to teachings that are well known in the art; pumpable application systems which could include the use of a baffle and bladder system; and sprayable applications.

The expandable material may be any of the expandable materials disclosed herein. In one embodiment, the expandable material is a material that experiences relatively high levels of expansion upon exposures to temperatures of between about 148.89° C. to 204.44° C. (about 300° F. to 400° F.) (i.e., temperatures typically experienced in automotive painting or coating operations). Accordingly, the preferred expandable material can be configured to have a volumetric expansion of at least about 1500%, more preferably at least about 2000%, even more preferably at least about 2500% and still more preferably at least about 3000% its original or unexpanded volume. An example of such an expandable material with such expansion capabilities is disclosed in commonly owned copending U.S. Patent Application titled Expandable Material, attorney docket # 1001-141P1, filed on the same date as the present application and fully incorporated herein by reference for all purposes. Of course, in other embodiments, the expandable material may be configured to have less volumetric expansion. For example, the expandable material may be configured to expand to at least 10% or less, more preferably at least 100% and even more preferably at least 300% it original or unexpanded volume.

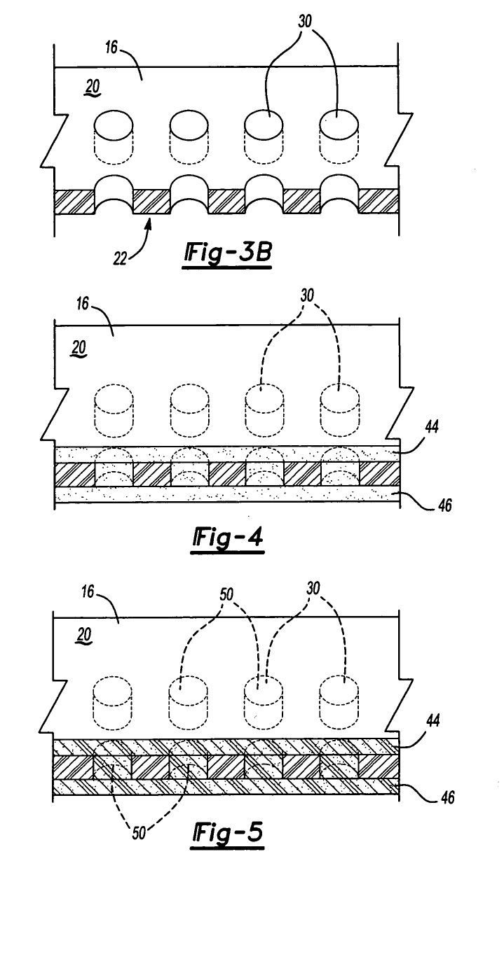

Once the expandable material is provided, at least one, but preferably a plurality of openings 30 is formed in the material. In FIGS. 3A-3B, the openings 30 are shown as through-holes extending through the layer 16 of the expandable material and, thus, through the first surface 20 and the second surface 22 of the layer 16. In FIG. 1 the openings 20 formed with a punch machine at a piercing station 34 wherein a plurality of protrusions 36 are employed to pierce the openings 20 in the layer 16.

It should be understood that a variety of techniques and machines can be employed for forming the opening[s] in the expandable material depending upon the configuration of the expandable material. Moreover, the openings may be formed in a variety of shapes and configurations such as cavities, channels, tunnels combinations thereof or the like.

Formation of a baffle according to the present invention also typically includes the formation of one or more layers upon the expandable material. Preferably, although not required, the layers are formed by applying a coating material to a portion or the entirety of one or more surfaces of the expandable material. The coating material may be applied to the expandable material using a variety of coating techniques including painting, dabbing, brushing, spraying, submersion, combinations thereof or the like.

In FIG. 1, the layer 16 of expandable material is submerged in a pool 40 of substantially liquid coating material such that the coating material forms a first layer 44 upon the first surface 20 of the expandable material and a second layer 46 upon the second surface 22 of the expandable material as shown in FIG. 4. As shown, the coating material also penetrates and substantially fills the openings 30.

After application and preferably before activation of expandable material, the coating material is at least partially cured (eg. 30%, 60%, 90%, cured or more) while it is disposed upon the expandable material. In the particular embodiment shown in FIG. 5, the layers 44, 46 will harden and preferably become substantially solid, rigid or the like upon curing. Additionally, the coating material in the openings 30 will also harden and preferably become substantially solid, rigid or the like for forming fastening or interconnecting members 50, which extend through the openings 30 and interconnect the first layer 44 to the second layer 46.

The coating material used for coating the expandable material and the method of curing the coating material will typically depend upon each other. As examples, the curing technique may include exposure to radiation, heat, moisture, chemical reaction, combinations thereof or the like at a curing station 54, as shown in FIG. 1, and the coating material will typically be susceptible to curing by such techniques. Alternatively, the coating material may simply cure over time at, for example, room temperature (e.g. about 10° C. to about 40° C.) without artificially exposing the material to any additional stimulus. Preferably, although not required, any stimulus employed to cure the coating material does not substantially activate the expandable material to expand or cure.

In one embodiment, the coating material is formed of a substantially liquid admixture that includes a substantial amount (e.g., greater than 50%) of a relatively high solids content resin, a high non-volatiles content resin or a low melting temperature (e.g., low molecular weight) solid resin such that the coating material is curable at a relatively low temperature (e.g. below about 120° C.) without activating the expandable material. The skilled artisan will recognize that various chemical systems, including but not limited to, polyurethane-based systems, phenolics-based systems, acrylate-based systems, epoxy-based systems, cross-linkable polyester-based systems, a combination thereof or the like can include such resins. Preferably, the admixture for the coating material has a relatively short cure time (e.g., preferably less than an hour and more preferably less than 20 minutes).

As an example of one desirable system, the admixture for the coating may include or be based upon epoxy resins and the admixture may include a relatively high percentage (e.g., greater than 30%, greater than 50% or more) of one or more high solid content epoxy resins, one or more non-volatile epoxy resins, one or more low melting temperature solid resins, a combination thereof or the like mixed with other ingredients (e.g., liquid resins, solvents, fillers, rheology modifiers, other solid resins, hydrocarbons combinations thereof or the like) to form the admixture as a liquid. In turn, the coating material will be curable to form a solid at temperatures only slightly above room temperature (e.g., about 40° C. to about 120° C., more preferably about 60° C. to about 120° C.). Thus, the coating material can be at least partially or substantially (i.e., greater than 50%) cured by exposure to heat or elevated temperature slightly above room temperature without substantially activating the expandable material to expand or cure. In such an embodiment, the curing station 54 may include an oven or any other heat evolving mechanism for curing the coating material.

In another embodiment, the coating material may be formed of an admixture that is chemically curable. The skilled artisan will recognize that various chemically reactive systems may be employed within the scope of the present invention. Examples include, but are not limited to, acid and amine cured epoxy systems, amine cured acrylic systems, polymeric systems that can be cured with a peroxide, sulfur, an amine, combinations thereof or the like.

As one example, it is contemplated that the coating material may be a resin admixture that includes an encapsulated curing agent. In the example, the encapsulated curing agent may be released into the coating material upon deterioration of the encapsulation such that the coating material cures upon the expandable material. Exemplary encapsulations can be self-deteriorating or may deteriorate upon the application of heat, pressure or other stimulus for causing the coating material to cure. Thus, the curing station 54 may include an oven or other heat evolving device or the curing station may simply be a location at which the expandable material and coating material are placed to await curing.

In yet another embodiment, the coating material may be an admixture that can be cured by exposure to radiation (e.g., UV radiation), microwaves or the like. The skilled artisan will recognize that various chemical systems, which can be cured or can include additives to assist in curing by exposure to radiation or microwaves, can be employed for use as the coating material. In such embodiments, the curing station 54 will typically include a radiation or microwave source for exposing the coating material to such radiation or microwaves.

It should be understood that the skilled artisan will be able to think of various additional alternative coating materials and curing techniques within the scope of the present invention.

Before, after or during curing of the coating material, the expandable material, the layers 44, 46 of coating material or a combination thereof may be shaped to form the baffle 10. Thus, the expandable material may be shaped as the baffle before or after applying the coating material to thereto. Moreover, the expandable material, the layers 44, 46 or a combination thereof may be shaped to form the baffle using a variety of techniques such as molding, cutting or the like.

In the embodiment illustrated in FIG. 1, the layer 16 of expandable material along with the first layer 44 and second layer 46 are cut (e.g., die cut) to shape by a cutter 60 (e.g., a die cutter) to form the baffle 10 as shown in FIG. 6 in conjunction with the partial side view (indicated by arrow 64 in FIG. 6) of the baffle as shown 6A. Thus, the first layer 44 discussed is the first (e.g., top) layer of the baffle 10 and the second layer 46 discussed is the second (e.g., bottom) layer of the baffle 10 and the layer 16 of expandable material is sandwiched therebetween.

The baffle 10 may be shaped or cut to any desired configuration. In FIGS. 6 and 6A, the baffle 10 has a generally rectangular body and a plurality of protrusions 70 extending therefrom. The baffle 10 also include a peripheral wall 74, which is defined by the first layer 44, the second layer 46, the layer 16 of expandable material or a combination thereof. Preferably, the peripheral wall 74 extends substantially entirely about the baffle 10, although not required.

Advantageously, the cutting of the baffle 10 can form the peripheral wall 74 to expose the expandable material between the layers 44, 46. However, it is contemplated that the peripheral wall 74 may formed to expose the expandable material according to other techniques as well. For example, the expandable material may be shaped (e.g., cut to shape) and it periphery may be masked by a material (e.g., tape) before coating such that, upon removal of the material after coating, the peripheral wall 74 exposes the expandable material between the layers 44, 46. As another example, the expandable material may be shaped and coated followed by removing (e.g., scoring or scraping away) portions of the coating at the peripheral wall 74 to expose the expandable material between the layers 44, 46.

For use, the baffle is typically assembled to a structure of an article of manufacture such as a transportation vehicle (e.g., an automotive vehicle), although it may be assembled to many other articles such as buildings, furniture or the like. The baffle may be assembled to such structures as needed or desired, however, it is often desirable for the baffle to have some degree of correspondence with the structure once assembled, although not required.

In FIG. 6, the baffle 10 is shown as assembled to a pillar 80 of an automotive vehicle. However, it is contemplated that the baffle may be assembled to various structures of an automotive vehicle or other article of manufacture. Exemplary structures of an automotive vehicle suitable for receipt of the baffle include roof structures, frame structure, body structures, engine structures, hood and trunk structures, combinations thereof or the like.

As shown, the pillar 80 has a generally rectangular cross-section with one or more walls 82 defining a cavity 84. The pillar 80 also has one or more openings 86. As can be seen, the protrusions 70 of the baffle 10 are received in the openings 86 of the pillar 80 for assembling the baffle 10 to the pillar 80. Once assembled, the peripheral wall 74 of the baffle 10 opposes the one or more walls 82 of the cavity 84 substantially entirely about the baffle 10 with the exception of the protrusions 70. Thus, the substantially rectangular configuration of the baffle 10 substantially corresponds to the substantially rectangular cross-section of the pillar 80. Of course, a baffle 90 may be shaped according to the present invention to correspond to nearly any structure 92 as is shown in FIG. 7.

After assembly, the expandable material of the baffle is typically activated to expand and then cure. Preferably, the expandable material activates and expands to contact and wet the walls of the structure surrounding the baffle followed by curing to adhere the expandable material to the walls. In the embodiment depicted in FIG. 6 and 6A, the layer 16 of expandable material is heated to activate (e.g., during a painting process) and expand from the peripheral wall 74 outwardly to the one or more walls defining the cavity 84 such that the expandable material contacts and wets the one or more walls 82. Then, the expandable material cools and cures to adhere to the walls 82 defining the cavity 84 and, in turn, substantially entirely or entirely divides and/or seals the cavity 84 particularly against passage of materials therethrough.

Advantageously, the layer 16 of expandable materials is substantially limited from expanding toward the first layer 44 and second layer 46. This is particularly the case since the fastening members 50 operate to restrict the movement of the first layer 44 and the second layer 46 away from each other. In turn, the expansion of the expandable layer 16 is more efficiently directed toward the walls 82 of the pillar 80 or other structure.

While the process of the present invention has been particularly described with relation to the baffle of FIGS. 6 and 6A, it should also be understood that the process and baffle of the present invention could be used in a broader sense. Generally, it is contemplated that any mass of expandable material may be at least partially coated with a coating material according to the present invention. In turn, that coating material may be cured upon the expandable material to form one or more layers that limit the expansion of the expandable material toward the layers.

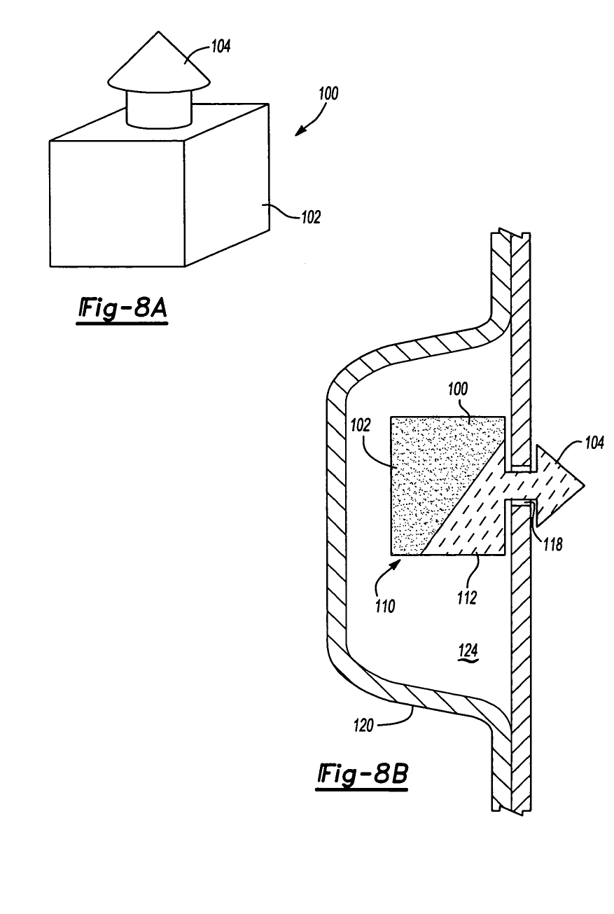

To illustrate this concept, reference is made to FIGS. 8A and 8B. In FIG. 8A, there is illustrated a mass 100 of expandable material having a generally block-shaped body portion 102 and an arrowhead shape fastening portion 104. Then, in FIG. 8B, there is illustrated a baffle 110 formed from the mass 100 of expandable material by coating a portion of the surface of the mass 100 with coating material to form a layer 112 that overlays substantially the entire fastening portion 104 and a part of the body portion 102.

As can be seen, the fastening portion 104 is received in an opening 118 of a structure 120 for securing the baffle 110 within a cavity of the structure 124. Upon activation of the expandable material, the layer 112 will limit the expansion of the material toward the layer 112 and will preferably assist in directing the expansion away from the layer 112.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A method of forming and using a baffle, comprising:
providing a mass of expandable material, the mass having a first surface opposite a second surface;
applying a coating material to the first surface leaving the second surface exposed;
at least partially curing the coating material for forming a first layer overlapping the first surface thereby forming the baffle;
positioning the baffle within a cavity of a structure such that the peripheral edge opposes one or more walls defining the cavity; and
expanding the expandable material to contact the one or more walls defining the cavity, whereby the first layer limits expansion of the expandable material toward the first layer.

2. A method as in claim 1 wherein the structure is part of an automotive vehicle.

3. A method as in claim 1 expandable material is expanded in a e- coat or paint bake oven.

4. A method as in claim 1 wherein the step of at least partially curing the coating material includes exposure of the coating material to at least one of radiation, microwaves, heat or a chemical.

5. A method as in claim 1 wherein the step of applying the coating material includes submerging the expandable material in a pool of the coating material.

6. A method as in claim 1 wherein the coating material is curable of a temperature below about 120° C.

7. A method as in claim 1 wherein the coating is at least 90% cured in less than 20 minutes.

8. A method as in claim 1 wherein the coating material is provide with an encapsulated curing agent.

9. A method of forming and using a baffle, comprising:
providing a mass of expandable material, the mass having a first surface opposite a second surface;
applying a liquid coating material to the first surface, the second surface;
at least partially curing the coating material for forming a first layer overlapping the first surface and a second layer overlapping the second;
shaping the mass of expandable material, the first layer and the second layer for forming the baffle such that the baffle has a peripheral wall at least partially defined by the first layer, the second layer and the mass of expandable material therebetween;
positioning the baffle within a cavity of a structure such that the peripheral edge opposes one or more walls defining the cavity; and
expanding the expandable material to contact the one or more walls defining the cavity whereby the first layer and second layer limit expansion of the expandable material toward the first layer and second layer.

10. A method as in claim 9 wherein the structure is part of an automotive vehicle.

11. A method as in claim 9 expandable material is expanded in a e-coat or paint bake oven.

12. A method as in claim 9 wherein the step of at least partially curing the coating material includes exposure of the coating material to at least one of radiation, microwaves, heat or a chemical.

13. A method as in claim 9 wherein the step of applying the coating material include submerging the expandable material in a pool of the coating material.

14. A method as in claim 1 wherein the coating material is curable of a temperature below about 120° C.

15. A method of forming and using a baffle, comprising:
providing a mass of expandable material, the mass having a first surface opposite a second surface;
forming at least one through-hole in the mass of expandable material wherein the opening extends through the first surface and the second surface and the opening is defined by at least one surface;
applying a liquid coating material to the first surface, the second surface and at least partially within the at least one opening;
at least partially curing the coating material for forming a first layer overlapping the first surface, a second layer overlapping the second surface and a connection member, which interconnects the first layer to the second layer through the opening;
die cutting the mass of expandable material, the first layer and the second layer for forming the baffle such that the baffle has a peripheral wall at least partially defined by the first layer, the second layer and the mass of expandable material therebetween;
positioning the baffle within a cavity of a structure such that the peripheral edge opposes one or more walls defining the cavity; and
expanding the expandable material to contact the one or more walls defining the cavity whereby the first layer and second layer limit expansion of the expandable material toward the first layer and second layer.

16. A method as in claim 15 wherein the structure is part of an automotive vehicle.

17. A method as in claim 1 wherein the step of at least partially curing the coating material includes exposure of the coating material to at least one of radiation, microwaves, heat or a chemical.

18. A method as in claim 15 wherein the step of applying the coating material include submerging the expandable material in a pool of the coating material.

19. A method as in claim 15 wherein the coating material is curable of a temperature below about 120° C.
